(19) United States
(12) Patent Application Publication
(10) Pub. No.: US 2014/0217884 A1
(43) Pub. Date: Aug. 7, 2014

(54) FLASH TUBE WITH AN EXTERNAL TRIGGERING WIRE

(71) Applicants: Anton Falk, Huddinge (SE); Ulf Carlsson, Stockholm (SE)

(72) Inventors: Anton Falk, Huddinge (SE); Ulf Carlsson, Stockholm (SE)

(73) Assignee: Profoto AB, Sundbyberg (SE)

(21) Appl. No.: 14/130,866

(22) PCT Filed: May 3, 2012
(86) PCT No.: PCT/SE2012/050459

§ 371 Date: Apr. 11, 2014

Related U.S. Application Data
(60) Provisional application No. 61/507,602, filed on Jul. 14, 2011.

(30) Foreign Application Priority Data
Jul. 14, 2011 (SE) 1150680-5

(51) Int. Cl. H01J 11/28

(52) U.S. Cl. CPC H01J 11/28
USPC 313/594

(57) ABSTRACT

The present invention relates to the field of flash tubes for photographic use, in particular to a flash tube comprising a trigger element for triggering a flash in the flash tube. Accordingly, a flash tube is provided. The flash tube comprises a glass envelope enclosing a gas for use in a flash tube; a first electrode inside the glass envelope; a second electrode inside the glass envelope; and an electrically conductive trigger element being configured to receive a high voltage pulse for at least partly ionizing the gas inside the glass envelope in order to trigg a flash in said flash tube, wherein said electrically conductive trigger element extends along the glass envelope from a first point on the glass envelope adjacent to the first electrode to a second point on the glass envelope adjacent to the second electrode such that a single unified spark stream which bridges the first and second electrodes inside the glass envelope is formed in the at least partly ionized gas adjacent to said electrically conductive trigger element when said electrically conductive trigger element receives the high voltage pulse.

### TECHNICAL FIELD

The present invention relates to the field of flash tubes for photographic use, in particular to a flash tube comprising a trigger element for triggering a flash in the flash tube.

### BACKGROUND

Today, in flash tubes used for photographic purposes, external triggering of the flash in the flash tube is a common method of operation. This is performed by having the electrodes of the flash tube charged up to a voltage level which is high enough to respond to a triggering event, but below the flash tube's self-flash threshold. Then, a high voltage pulse, which normally may be between 2000 and 150,000 Volts, is externally applied directly to or close to the glass envelope of the flash tube. This may also be referred to as a “trigger pulse”.

This short duration, high voltage pulse creates a rising electrostatic field, which ionizes the gas inside the glass envelope of the flash tube. The capacitance of the glass couples the trigger pulse into the glass envelope, where it exceeds the breakdown voltage of the gas surrounding one or both of the electrodes, generating a plurality of spark streamers. The plurality of spark streamers will propagate randomly through the gas and via capacitance along the glass at a speed of about 1 centimeter in 60 nanoseconds, that is, around 170 km/s. It should be noted that a trigger pulse must have long enough duration to allow at least one of the plurality of random spark streamers generated to reach the opposite electrode, otherwise erratic triggering will occur. When at least one of the random spark streamers has bridged the electrodes, the charged-up voltage will discharge through the ionized gas, and cause a heating of the gas (e.g. Xenon) to a high enough temperature for the emission of light, i.e. generate a flash.

FIG. 1 shows an example of a conventional flash tube 1 according to prior art having external triggering. The flash tube 1 comprises a glass envelope 2 enclosing a gas 3. One electrode 4, 5 is provided at each end inside the glass envelope 2, where the electrodes 4, 5 protrudes out of the glass envelope 2 and connects to two electrical connectors 4A, 5A. The two electrical connectors 4A, 5A are arranged to receive and apply a voltage between the two electrodes 4, 5. The two electrodes 4, 5 may be charged up to a suitable voltage level, V₁, using e.g. a capacitor (not shown).

Conventionally, a triggering wire 6 is tied and wrapped in a spiral around the circumference of the glass envelope 2 of the flash tube 1. This type of trigger wiring is mainly performed for two reasons. Firstly, the triggering wire 6 will in this case cover a large portion of the area of the glass envelope 2 of the flash tube 1, and hence the triggering wire 6 will ionize a large portion of the gas 3 inside the glass envelope 2 and in doing so increase the probability that at least one of the plurality of random spark streamers 21, 31 will bridge between the electrodes 4, 5. Secondly, the wire material commonly used for the triggering wire 6 is nickel (Ni). Nickel is a soft metal and to make a good fixation of the nickel wire the “spiral shaped wiring” is the straight forward method to apply.

The trigger pulse, Vₚᵤₗₛₑ, may be applied to the triggering wire 6 through an electrically conductive connector, such as, e.g. a metal band 7. The electrically conductive connector 7 may be arranged to be received by a corresponding electrical connector in a flash lamp apparatus. The flash lamp apparatus may be arranged to generate the trigger pulse, and deliver the trigger pulse to the flash tube 1 via the electrical connectors.

However, a disadvantage often experienced with conventional flash tubes 1 having external triggering according to the above is that each flash that is generated is usually different from each other, that is, the emitted light from one flash often comprises a different colour temperature than a subsequent flash from the same flash tube 1. Thus, it is difficult to achieve the same particular type of light characteristics for the light emitted from a flash tube during a first and a subsequent flash.

### SUMMARY

It is an object to obviate at least some of the above mentioned disadvantages and provide a flash tube that is able to emit light with similar type of light characteristics for a first and a subsequent flash.

Accordingly, a flash tube is provided. The flash tube comprises a glass envelope enclosing a gas for use in a flash tube; a first electrode inside the glass envelope; a second electrode inside the glass envelope; and an electrically conductive trigger element being configured to receive a high voltage pulse for at least partly ionizing the gas inside the glass envelope in order to trigg a flash in said flash tube, wherein said electrically conductive trigger element extends along the glass envelope from a first point on the glass envelope adjacent to the first electrode to a second point on the glass envelope adjacent to the second electrode such that a single unified spark stream which bridges the first and second electrodes inside the glass envelope is formed in the at least partly ionized gas adjacent to said electrically conductive trigger element when said electrically conductive trigger element receives the high voltage pulse.

One advantage of the flash tube described above is that the electrically conductive trigger element will repetatively provide the same conductive path through the gas having the same length for the single unified spark stream of each triggering of a flash in the flash tube. Thus, for each flash, the speed of the discharge will be the same, and every course of “plasma build-up” of the gas inside the glass envelope of the flash tube will propagate in the same manner from flash to flash. Thus, the effect on the colour temperature of the emitted light and the difference in lighting conditions of subsequent flashes made by the same flash tube may be minimised. This will improve the stability and reproducibility of the light emitted by the flash tube during a flash. Hence, a flash tube that is able to emit light with similar type of light characteristics for a first and a subsequent flash is provided.

The single unified spark stream between the electrodes will also minimise the number of random spark streams formed in the glass envelope.

The electrically conductive trigger element may extend linearly along the glass envelope between the first point and the second point on the glass envelope and/or along a route on the glass envelope providing the minimum distance between the first point and the second point on the glass envelope. This advantageously provides two examples of conductive paths of the electrically conductive trigger element along the glass envelope of the flash tube.

The electrically conductive trigger element may be made of a non-magnetic material. This advantageously prevents the electrically conductive trigger element from moving or being deformed during a flash. This is because, during a flash, a magnetic field will be formed by the plasma inside the flash tube, which may affect any adjacent magnetic material.

The electrically conductive trigger element may be an electrically conductive coating or paint. Alternatively, the electrically conductive trigger element may be an electrically conductive metal wire. This advantageously provides two different examples of implementing the electrically conductive trigger element on the glass envelope of the flash tube.

The electrically conductive trigger element may be made of an alloy from the group of Hastelloy C-276 (Ni 55%, Mo 15-17%, Cr 14-17%, Fe 4-7%, W 3-5%) and Nimonic 90 (Ni 54%, Cr 18-21%, Co 15-21%, Ti 2-3%, Al 1-2%). This advantageously provides two different examples of implementing the electrically conductive trigger element on the glass envelope of the flash tube, which are non-magnetic and capable of withstanding the high temperatures (e.g. above 300° C.) which are generated during a flash without being deformed or destroyed.

In case of using an electrically conductive metal wire as the electrically conductive trigger element, the flash tube may further comprise holding elements for holding the electrically conductive metal wire attached to the glass envelope. This advantageously provides one example of fixating the electrically conductive metal wire to the glass envelope of the flash tube as described above.

For example, a first holding element may form a hookshaped protrusion about which the electrically conductive metal wire is fastened at the first point on the glass envelope adjacent to the first electrode, and a second holding element may form a hookshaped protrusion about which the electrically conductive metal wire is fastened at the second point on the glass envelope adjacent to the second electrode. This may advantageously provide anchor points on the glass envelope which may utilize inherent stiffness of an electrically conductive metal wire to hold the electrically conductive metal wire attached to the glass envelope of the flash tube. Also, at least a third and a fourth holding element may form protrusions configured to guide the electrically conductive metal wire on the glass envelope on the flash tube. This may further aid in assuring that the electrically conductive metal wire held in place on the glass envelope of the flash tube. Furthermore, the holding elements may be protruding from said glass envelope and be made of glass.

Further, the first electrode may be the anode of the flash tube and the second electrode may be the cathode of the flash tube, or vice versa.

### BRIEF DESCRIPTION OF THE DRAWINGS

The above and other features and advantages of the present invention will become readily apparent to those skilled in the art by the following detailed description of exemplary embodiments thereof with reference to the accompanying drawings, wherein:

FIG. 1 schematically illustrates an example of a conventional flash tube 1 according to prior art having external triggering,

FIG. 2 schematically illustrates an example of a plurality of random spark streamers in the flash tube 1 for a first triggering pulse,

FIG. 3 schematically illustrates an example of a plurality of random spark streamers in the flash tube 1 for a second triggering pulse,

FIG. 4 schematically illustrates a flash tube according to an embodiment of the invention,

FIG. 4A schematically illustrates a sample cross-section of a flash tube according to an embodiment of the invention,

FIG. 4B schematically illustrate two sample cross-sections of a flash tube according to an embodiment of the invention,

FIG. 5 schematically illustrates a flash tube according to an embodiment of the invention,

FIG. 6-7 schematically illustrates example of a spark stream in the flash tube shown in FIG. 4 and in FIG. 5, respectively,

FIG. 8 schematically illustrates a flash tube according to an embodiment of the invention.

### DESCRIPTION

The figures are schematic and simplified for clarity, and they merely show details which are essential to the understanding of the invention, while other details have been left out. Throughout, the same reference numerals are used for identical or corresponding parts.

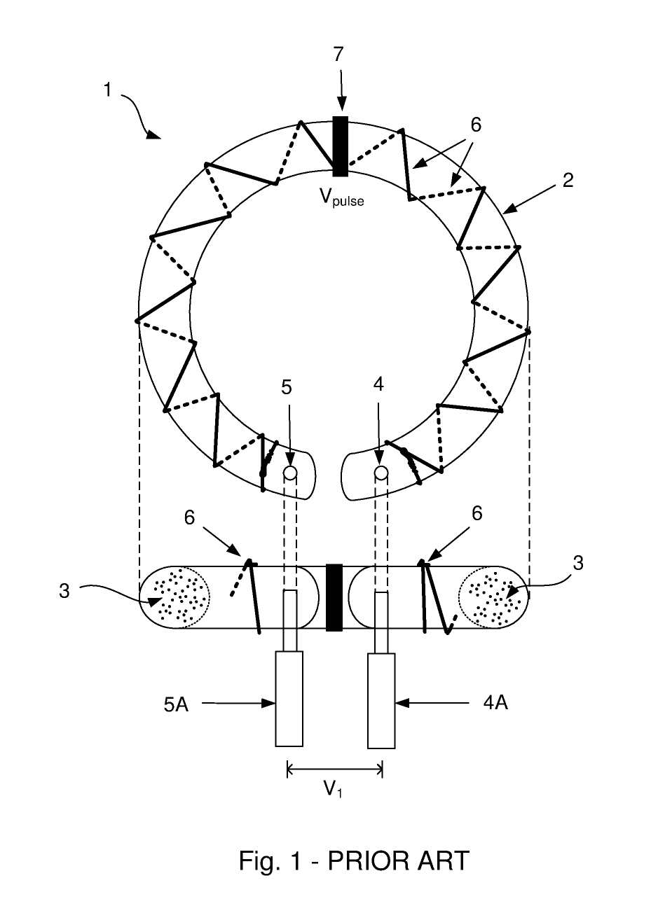

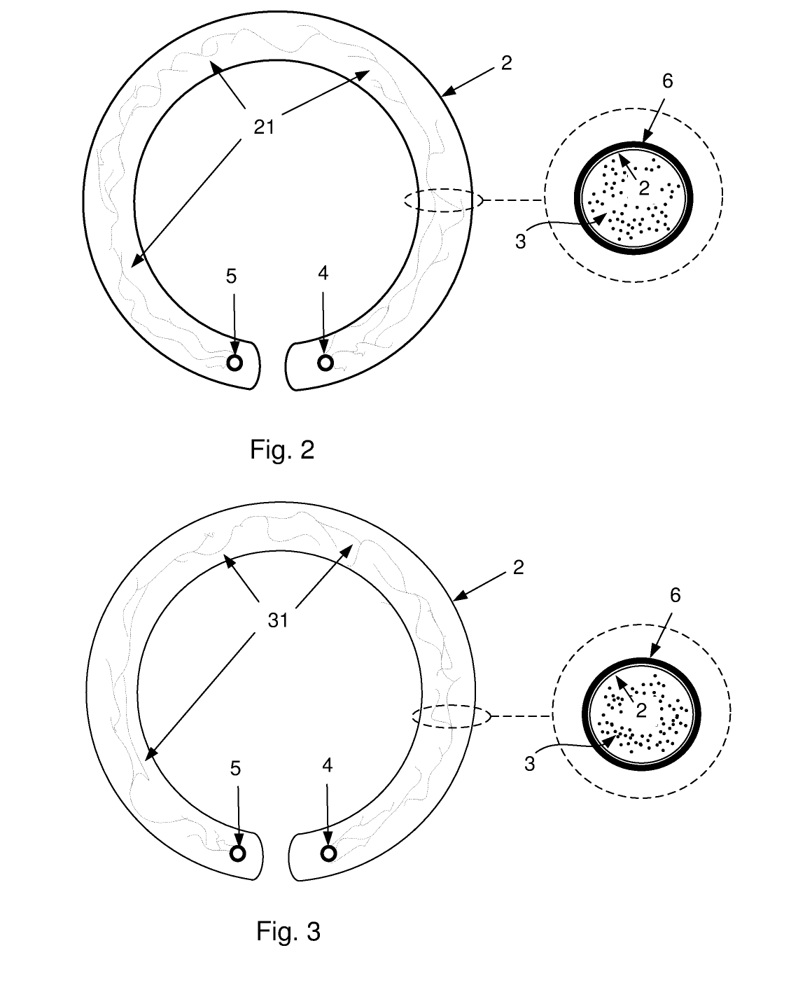

FIGS. 2-3 shows a plurality of random spark streamers 21, 31 ionizing the gas 3 inside the glass envelope 2 of the flash tube 1 in FIG. 1. These are generated respectively when applying a first and a second triggering pulse to the triggering wire 6 at two separate occasions in order to trigg a first and a second flash in the flash tube 1, respectively.

According to the invention, it has been found that in conventional flash tubes having external triggering, such as, the flash tube 1 in FIGS. 1-3, there is a problem with the conventional trigger wire 6 in that the plurality of spark streamers 21, 31 that is created between the electrodes 4, 5 varies from flash to flash (as shown in FIGS. 2-3). The plurality of spark streamers 21, 31 are often made of a number of spark streams that may be randomly created inside the glass envelope 2 of the flash tube 1. When the charged-up voltage V₁ starts to discharge through these ionized gas channels (i.e. bridges) 21, 31, the speed of the discharge are truly dependent on the number of spark streams and the length of each spark stream. Thus, it follows that every course of “plasma build-up” of the gas inside the glass envelope 2 of the flash tube 1 will propagate differently from flash to flash. This has been discovered to affect the colour temperature of the emitted light for a flash and consequently lead to a difference in lighting conditions of subsequent flashes made by the same flash tube 1.

It was realised that some of the spark streamers in the plurality of spark streamers in conventional flash tubes, such as, the flash tube 1 in FIGS. 1-3, are established randomly in the gas at various distances from and along the entire trigger wire 6 of the flash tube 1. The rising electrostatic field inside the glass envelope 2 will be strongest close to the trigger wire 6 making the ionization more likely closer to the trigger wire 6, however, random shortcuts of the plurality of spark streams are often established in the gas 2 on a route that is not closest to the trigger wire 6. This is because the plurality of spark streamers 21, 31 naturally strive to take the shortest electrical route through the gas between two points on the trigger wire 6. In the flash tube 1 in FIGS. 1-3, the shortest electrical route will sometimes, rather than via the gas closest to the trigger wire 6 and the glass envelope 2, be elsewhere through the gas in between two points on the trigger wire 6.

Thus, according to the invention, it was then realised that the problems described above may be solved by arranging an electrically conductive trigger element on the glass envelope of a flash tube such that the spark streams are unified into a single unified spark stream when bridging the electrodes inside the glass envelope when said electrically conductive trigger element receives the high voltage pulse. A single unified spark stream between the electrodes will minimise the number of random spark streams. Such an electrically conductive trigger element will also repetatively provide the same conductive path through the gas having the same length for the single unified spark stream for each triggering of a flash in the flash tube. Thus, for each flash, the speed of the discharge will be the same, and every course of “plasma build-up” of the gas inside the glass envelope of the flash tube will propagate in the same or similar manner from flash to flash. Thus, the effect on the colour temperature of the emitted light and the difference in lighting conditions of subsequent flashes made by the same flash tube may be minimised. This will improve the stability and reproducibility of the light emitted by the flash tube over a plurality of flashes.

The term “single unified spark stream” is here used to denote the coherent spark stream resulting from the conductive path through the gas repetitatively provided by the electrically conductive trigger element when being arranged according to the different embodiments shown herein.

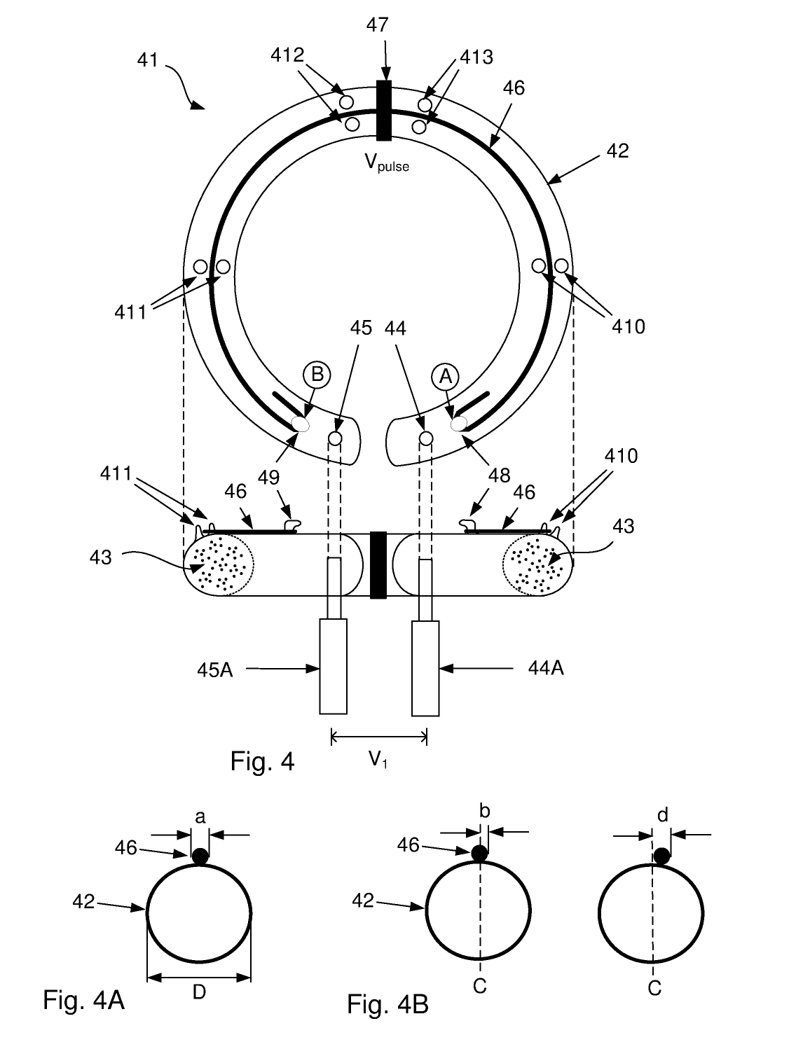

Some embodiments are described below in reference to FIGS. 4-8.

FIG. 4 illustrates a flash tube 41 according to one embodiment of the invention. The upper part of FIG. 4 shows a view of the flash tube 41 from above, and the lower part of FIG. 4 shows a side-view of the flash tube 41. The flash tube 41 comprises a glass envelope 42 enclosing a gas 43. Although, the glass envelope 42 of the flash tube 41 is here described having a circular tube shape, it should be noted that the glass envelope 42 of the flash tube 41 may be of many different shapes, such as, for example, straight tube shape, spiral shaped, U-shaped, helical shaped, ring shaped, etc. Therefore, this exemplary embodiment should not be construed as limiting to the invention in this respect. The gas 43 is a gas suitable for use in a flash tube, such as, for example, Xenon (Xe), Argon (Ar), Neon (Ne), etc.

A first electrode 44 is provided at one end of the flash tube 41 inside the glass envelope 42. A second electrode 45 is provided at the other end of the flash tube 41 inside the glass envelope 42. The first electrode 44 may be the anode of the flash tube 41 and the second electrode 45 may be the cathode of the flash tube 41, or vice versa. The electrodes 44, 45 protrude out of the glass envelope 42 and connect to two electrical connectors 44A, 45A, respectively. The two electrical connectors 44A, 45A are arranged to receive and discharge a charged-up voltage over the two electrodes 44, 45. The two electrodes 4, 5 may be charged up to a suitable voltage level, V₁, using e.g. a capacitor (not shown). Capacitor(s) and electrical connectors for receiving the two electrical connectors 44A, 45A may be provided in, for example, a conventional flash lamp apparatus.

An electrically conductive trigger element 46 is provided on the glass envelope 42 of the flash tube 41. In this example, the electrically conductive trigger element 46 is an electrically conductive metal wire. The metal wire may be made of a non-magnetic material. The metal wire may also be made of an alloy included in, but not limited to, the group of alloys comprising Hastelloy C-276 (Ni 55%, Mo 15-17%, Cr 14-17%, Fe 4-7%, W 3-5%) and Nimonic 90 (Ni 54%, Cr 18-21%, Co 15-21%, Ti 2-3%, Al 1-2%). This group of alloys may also comprising further alloys having similar characteristics.

The electrically conductive trigger element 46 extends along a path on the glass envelope 42 from a first point A on the glass envelope 42, which is adjacent to the first electrode 44, to a second point B on the glass envelope 42, which is adjacent to the second electrode 45. For practical reasons, such as, for example, since the glass envelope 42 often has a joint or splice close to the electrodes 44, 45 making it difficult to attach any holding elements 48, 49, 411, 412, 413, 414 to holding the electrically conductive trigger element 46 to the glass envelope 42 without forming local tension in the glass envelope 42, the electrically conductive trigger element 46 may be terminated before points on the glass envelope 42 that are closest to the first and second electrodes 44, 45. However, the electrically conductive trigger element 46 should not terminate at a distance too far from the points on the glass envelope 42 that are closest to the first and second electrodes 44, 45. This is because the further away from the electrodes 44, 45 the electrically conductive trigger element 46 ends, the further the uncontrolled part of the unified spark stream becomes. According to one example, the electrically conductive trigger element 46 should terminate not further than 1 cm from the first and second electrodes 44, 45.

In this embodiment, wherein an electrically conductive metal wire 46 is used as the electrically conductive trigger element, the flash tube 41 may comprise holding elements 48, 49, 411, 412, 413, 414 for holding the electrically conductive metal wire 46 attached to the glass envelope 42. In FIG. 4, for example, hookshaped protrusions 48, 49 about which the electrically conductive metal wire 46 is fastened may be located at the first point A on the glass envelope 42 adjacent to the first electrode 44, and at the second point B on the glass envelope 42 adjacent to the second electrode 45. Also, further protrusions 411, 412, 413, 414 may be located on the glass envelope 42 and be configured to guide and hold the electrically conductive metal wire 46 on the glass envelope 42 on the flash tube 41. Furthermore, the holding elements or protrusions 48, 49, 411, 412, 413, 414 may, for example, be made of glass.

The electrically conductive trigger element 46 may be described as extending linearly along the glass envelope 42 between the first point A and the second point B on the glass envelope 42. Here, the term “linearly” should not be construed as limiting, but rather as pertaining to or resembling a line. The electrically conductive trigger element 46 may also be described as extending along a route on the glass envelope 42 providing the minimum distance between the first point A and the second point B on the glass envelope 42. In order to illustrate this, two examples which illustrate how the electrically conductive trigger element 46 accordingly may be arranged on the glass envelope 42 are shown in FIGS. 4A-4B.

FIG. 4A schematically illustrates a sample cross-section of the flash tube 42 according to an embodiment of the invention. If, for example, the flash tube 42 is divided into a number of cross-sectional parts, such as, the sample cross-section shown in FIG. 4A, each cross-sectional part should only have one electrically conductive trigger element 46. This electrically conductive trigger element 46 should preferably only cover a maximum of about 10% of the circumference of the flash tube 42, that is, aₘₐₓ≦2π·D.

FIG. 4B schematically illustrates two sample cross-sections of the flash tube 42 according to an embodiment of the invention. If, for example, the flash tube 42 is divided into a number of equally sized cross-sectional parts, such as, the sample cross-sections shown in FIG. 4B, the position of the electrically conductive trigger element 46 of each subsequent cross-sectional part should preferably not be displaced, perpendicularly to length of the flash tube 42, for more than half of the thickness of the cross-sectional parts as compared to the position of the electrically conductive trigger element 46 of the preceeding cross-sectional part. In FIG. 4B, for example, the electrically conductive trigger element 46 of the left-most cross-sectional part is centered on the flash tube 42 at the center line C. This means the center of the electrically conductive trigger element 46 of the next subsequent cross-sectional part (that is, the right-most cross-sectional part) should not be displaced from the center line C for more than half of the thickness of the cross-sectional parts, that is, |d−b|=max (0.5×thickness of cross-sectional part). According to another example, in case the flash tube 42 is divided into a number of equally sized cross-sectional parts being 1 mm thick, the position of the electrically conductive trigger element 46 on one cross-sectional part (e.g. the left-most cross-sectional part in FIG. 4B) and the position of the electrically conductive trigger element 46 on the subsequent cross-sectional part (e.g. the right-most cross-sectional part in FIG. 4B) should not deviate more than 0.5 mm, i.e. |d−b|=max 0.5 mm. However, it can also be shown that an exception may be made for up to two subsequent cross-sectional parts, where the electrically conductive trigger element 46 may comprise an interruption or extend in a different manner, without having any significant effect on the performance of the flash tube 42.

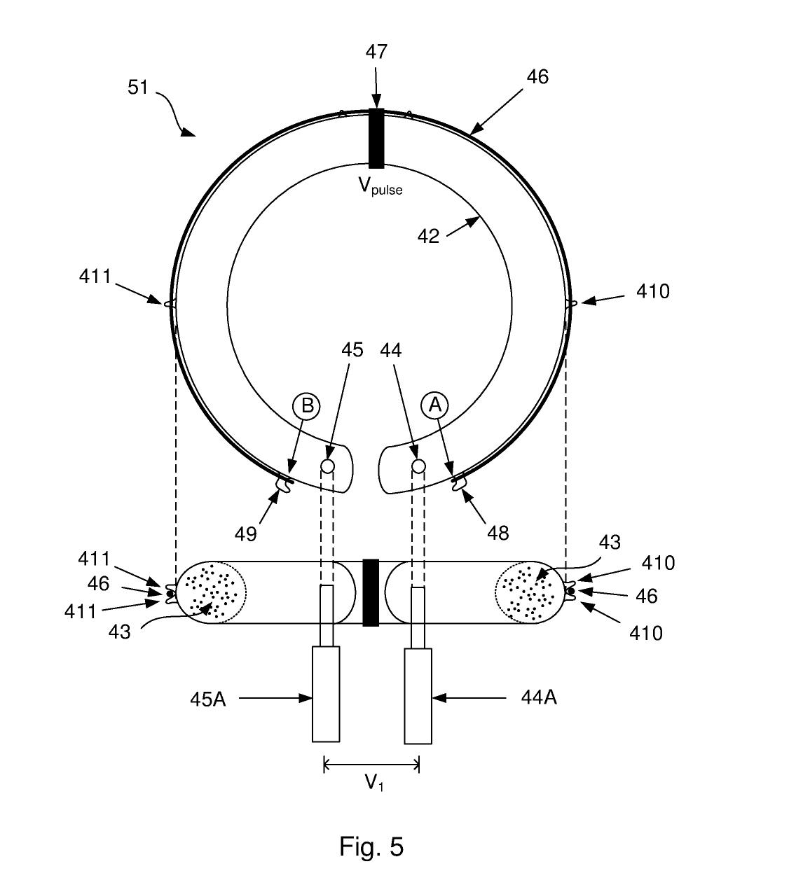

FIG. 5 illustrates a flash tube 51 according to an embodiment of the invention. The flash tube 51 is identical to the flash tube 41, except in that the electrically conductive trigger element 46 is arranged along the outer circumference of the flash tube 51 instead of arranged on the top or bottom of the flash tube, such as, for the flash tube 41. It should be understood that the electrically conductive trigger element 46 may also be arranged along the inner circumference of the flash tube 51. Furthermore, it should also be understood that the invention should not be construed as limited to these embodiments, but that these embodiments are merely examples of preferred configurations of the electrically conductive trigger element 46 onto the flash tube 41, 51.

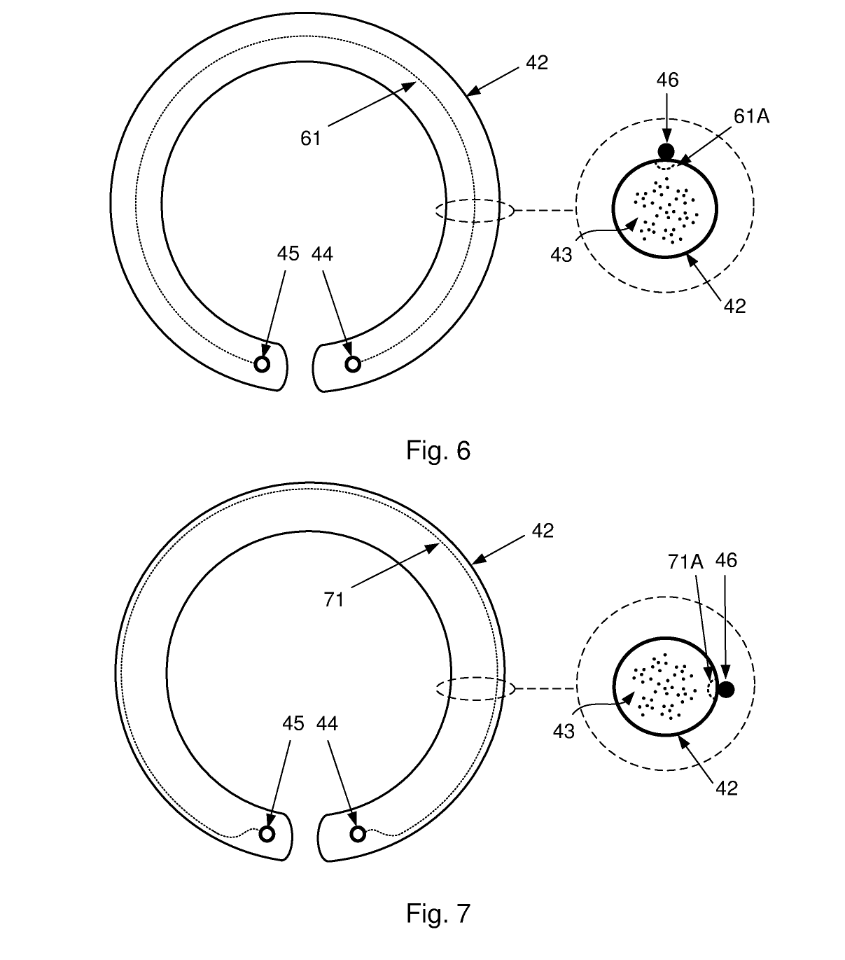

FIG. 6-7 schematically illustrates examples of a single unified spark stream in the flash tube 41 corresponding to the view shown in FIG. 4 and in the flash tube 51 corresponding to the view shown in FIG. 5, respectively. Here, it can be seen that the rising electrostatic field inside the glass envelope 42 will be strongest close to the electrically conductive trigger element 46, that is, for example, within an area 61A, 71A, making the ionization more likely close to the electrically conductive trigger element 46, and less likely further away from the electrically conductive trigger element 46. By having the electrically conductive trigger element 46 configured according to the invention, the establishment of random shortcuts of spark streams in the gas 43 on a route that is not closest to the electrically conductive trigger element 46 is avoided, since there are no longer any more shorter electrical routes through the gas between two points on the the electrically conductive trigger element 46. A single unified spark stream 61, 71 will instead only be formed between the electrodes 44, 45 close to the electrically conductive trigger element 46, that is, for example, within the areas 61A, 71A.

The electrically conductive trigger element 46 will thus repetatively provide the same conductive path, that is, for example, within the areas 61A, 71A, through the gas 43 having the same length for the single unified spark stream 61, 71 of each triggering of a flash in the flash tube 41, 51. Thus, for each flash, the speed of the discharge will be the same, and every course of “plasma build-up” of the gas 43 inside the glass envelope 42 of the flash tube 41, 51 will propagate in the same or similar manner from flash to flash. Thus, the effect on the colour temperature of the emitted light and the difference in lighting conditions of subsequent flashes made by the same flash tube 41, 51 may be minimised. This will improve the stability and reproducibility of the light emitted by the flash tube 41, 51 over a plurality of flashes. Hence, the flash tube 41, 51 is able to emit light with similar type of light characteristics for a first and a subsequent flash.

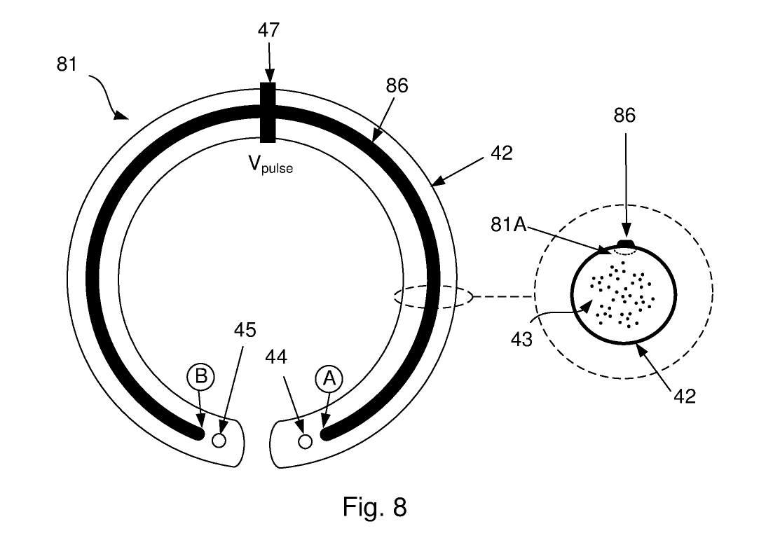

FIG. 8 schematically illustrates a flash tube 81 according to an embodiment of the invention. The flash tube 81 is identical to the flash tubes 41, 51, except in that the electrically conductive trigger element 86 is an electrically conductive coating or paint. The electrically conductive coating or paint 86 is configured onto the flash tube 81 along a path corresponding to the path described for the triggering wire 46 of the flash tube 41, 51. The electrically conductive coating or paint 86 also provides the same functionality for the flash tube 81 as the triggering wire 46 for the flash tube 41, 51, as described above. That is, the rising electrostatic field inside the glass envelope 42 will be strongest close to the electrically conductive coating or paint 86, that is, for example, within an area 81A, making the ionization more likely close to the electrically conductive coating or paint 86, and less likely further away from the electrically conductive coating or paint 86.

The electrically conductive coating or paint 86 may comprise a non-magnetic material. The electrically conductive coating or paint 86 may also comprise an alloy from the group of alloys comprising Hastelloy C-276 (Ni 55%, Mo 15-17%, Cr 14-17%, Fe 4-7%, W 3-5%) and Nimonic 90 (Ni 54%, Cr 18-21%, Co 15-21%, Ti 2-3%, Al 1-2%).

The electrically conductive coating or paint 86 may be applied to the flash tube 81 in a number of ways. The electrically conductive coating or paint 86 may be painted or spraypainted onto the flash tube 81. The electrically conductive coating or paint 86 may be applied to the flash tube 81 using metal vaporization. The electrically conductive coating or paint 86 may be applied to the flash tube 81 by dipping the flash tube 81 in a liquid comprising the electrically conductive coating or paint 86. The flash tube 81 may then be dried in order to fix the electrically conductive coating or paint 86 onto the flash tube 81. For these methods, a suitable masking of the flash tube 81 may be made such that the un-masked parts of the flash tube 81 allows the electrically conductive coating or paint 86 to fix to the flash tube 81 according to a path on the glass envelope 42 extending from a first point A on the glass envelope 42, which is adjacent to the first electrode 44, to a second point B on the glass envelope 42, which is adjacent to the second electrode 45.

It should be noted that in addition to the exemplary embodiments of the invention shown in the accompanying drawings, the invention may be embodied in different forms and should not be construed as limited to the embodiments set forth herein. Rather, these embodiments are provided so that this disclosure will be thorough and complete, and will fully convey the concept of the invention to those skilled in the art.

1. A flash tube comprising:
a glass envelope enclosing a gas for use in a flash tube;
a first electrode inside the glass envelope;
a second electrode inside the glass envelope; and
an electrically conductive trigger element being configured to receive a high voltage pulse for at least partly ionizing the gas inside the glass envelope in order to trigger a flash in said flash tube,
wherein:
the electrically conductive trigger element extends along the glass envelope from a first point on the glass envelope adjacent to the first electrode to a second point on the glass envelope adjacent to the second electrode such that a single unified spark stream which bridges the first and second electrodes inside the glass envelope is formed in the at least partly ionized gas adjacent to said electrically conductive trigger element when said electrically conductive trigger element receives the high voltage pulse.

2. A flash tube according to claim 1, wherein said electrically conductive trigger element extends linearly along the glass envelope between the first point and the second point on the glass envelope.

3. A flash tube according to claim 1, wherein said electrically conductive trigger element extends along a route on the glass envelope providing the minimum distance between the first point and the second point on the glass envelope.

4. A flash tube according to claim 1, wherein said electrically conductive trigger element is made of a non-magnetic material.

5. A flash tube according to claim 1, wherein said electrically conductive trigger element is an electrically conductive coating or paint.

6. A flash tube according to claim 1, wherein said electrically conductive trigger element is an electrically conductive metal wire.

7. A flash tube according to claim 5, wherein said electrically conductive trigger element is made of an alloy from the group of Hastelloy C-276 (Ni 55%, Mo 15-17%, Cr 14-17%, Fe 4-7%, W 3-5%) and Nimonic 90 (Ni 54%, Cr 18-21%, Co 15-21%, Ti 2-3%, Al 1-2%).

8. A flash tube according to claim 6, further comprising holding elements for holding the electrically conductive metal wire attached to the glass envelope.

9. A flash tube according to claim 8, wherein a first holding element forms a hookshaped protrusion about which the electrically conductive metal wire is fastened at the first point on the glass envelope adjacent to the first electrode, and a second holding element forms a hookshaped protrusion about which the electrically conductive metal wire is fastened at the second point on the glass envelope adjacent to the second electrode.

10. A flash tube according to claim 8, wherein at least a third and a fourth holding element are protrusions configured to guide the electrically conductive metal wire.

11. A flash tube according to claim 8, wherein the holding elements are protruding from said glass envelope and are made of glass.

12. A flash tube according to claim 1, wherein the first electrode is the anode of the flash tube and the second electrode is the cathode of the flash tube, or vice versa.
